(19) United States
(12) Patent Application Publication
(10) Pub. No.: US 2025/0319612 A1
(43) Pub. Date: Oct. 16, 2025

(54) CELL STACK GRIPPING SYSTEM AND METHOD

(71) Applicant: Ford Global Technologies, LLC, Dearborn, MI (US)

(72) Inventors: Matthew J. Mahler, Royal Oak, MI (US); Marc Dugas, Wixom, MI (US); Agasaperumal Subramanian, Chennai (IN); Mahalingam Elango; Frank Reiter, Plymouth, MI (US)

(21) Appl. No.: 18/635,283

(22) Filed: Apr. 15, 2024

(51) Int. Cl. B25J 15/00

(52) U.S. Cl. CPC B25J 15/0028; B25J 15/0071

(57) ABSTRACT

A cell stack gripping system includes a first gripper bar, a second gripper bar, a first clamp plate, a second clamp plate, and an actuator assembly. The actuator assembly can move the first and second gripper bars from a disengaged position with a cell stack to an engaged position with the cell stack. In the disengaged position, the first and second gripper bars are spaced further from each other than when the first and second gripper bars are in the engaged position. In the engaged position, the first and second gripper bars grip opposing sides of a cell stack having battery cells disposed along a cell stack axis. The opposing sides facing outward away from the cell stack axis. In the engaged position, the first and second gripper bars couple to the first and second clamp plates to hold an axial position of the battery cells.

### TECHNICAL FIELD

This disclosure relates generally to a battery pack and, more particularly, to installing a cell stack within the battery pack while maintaining compression on the cell stack.

### BACKGROUND

Electrified vehicles include a traction battery pack for powering electric machines and other electrical loads of the vehicle. The traction battery pack includes a plurality of battery cells and various other battery internal components that support electric vehicle propulsion.

### SUMMARY

In some aspects, the techniques described herein relate to a cell stack gripping system, including: a first gripper bar; a second gripper bar; a first clamp plate; a second clamp plate; and an actuator assembly that moves the first and second gripper bars from a disengaged position with a cell stack to an engaged position with the cell stack, in the disengaged position, the first and second gripper bars are spaced further from each other than when the first and second gripper bars are in the engaged position, in the engaged position, the first and second gripper bars grip opposing sides of a cell stack having a plurality of battery cells disposed along a cell stack axis, the opposing sides facing outward away from the cell stack axis, in the engaged position, the first and second gripper bars couple to the first and second clamp plates to hold an axial position of the battery cells along the cell stack axis.

In some aspects, the techniques described herein relate to a cell stack gripping system, wherein the opposing sides are horizontally facing sides.

In some aspects, the techniques described herein relate to a cell stack gripping system, wherein the first and second gripper bars directly contact short sides of the battery cells when the first and second gripper bars are in the engaged position.

In some aspects, the techniques described herein relate to a cell stack gripping system, further including coupling the first and second gripper bars to the first and second clamp plate using a plurality of pins received within respective apertures.

In some aspects, the techniques described herein relate to a cell stack gripping system, wherein the clamp plates directly interface with opposing axially facing surfaces of the cell stack when the first and second gripper bars are in the engaged position.

In some aspects, the techniques described herein relate to a cell stack gripping system, wherein the clamp plates directly interface with vertically upper portions of the opposing axially facing surfaces.

In some aspects, the techniques described herein relate to a cell stack gripping system, further including an insertion pusher that presses the cell stack into an enclosure structure when the first and second gripper are in the disengaged position.

In some aspects, the techniques described herein relate to a cell stack gripping system, wherein the enclosure structure is an enclosure tray that compresses the cell stack.

In some aspects, the techniques described herein relate to a cell stack gripping method, including: positioning first and second gripper bars along opposing sides of a cell stack, the cell stack including a plurality of battery cells disposed along a cell stack axis, the plurality of battery cells sandwiched axially between first and second clamp plates during the positioning; and moving the first and second gripper bars toward each other into an engaged position to couple to clamp the cell stack between the first and second gripper bars and to engage first and second clamp plates.

In some aspects, the techniques described herein relate to a gripping method, further including compressing the cell stack axially prior to the positioning.

In some aspects, the techniques described herein relate to a gripping method, further including maintaining the compressing during the moving.

In some aspects, the techniques described herein relate to a gripping method, further including compressing the cell stack axially at a compression table prior to the positioning.

In some aspects, the techniques described herein relate to a gripping method, further including withdrawing the cell stack from the compression table after the moving while maintaining compression on the cell stack.

In some aspects, the techniques described herein relate to a gripping method, further including inserting the cell stack into an enclosure structure.

In some aspects, the techniques described herein relate to a gripping method, further including moving the first and second gripper bars away from each other into a disengaged position, and then pressing the cell stack into the enclosure structure.

In some aspects, the techniques described herein relate to a gripping method, further including maintaining compression on the cell stack with the enclosure structure after the moving the gripper bars to the disengaged position.

In some aspects, the techniques described herein relate to a gripping method, wherein the first and second gripper bars directly contact horizontally facing sides of the plurality of battery cells when the gripper bars are in the engaged position.

In some aspects, the techniques described herein relate to a gripping method, wherein the first and second gripper bars directly contact short sides of the plurality of battery cells when the gripper bars are in the engaged position.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 shows a side view of an electrified vehicle according to an exemplary embodiment of the present disclosure

FIG. 2 illustrates a schematic, perspective view of a battery pack from the electrified vehicle of FIG. 1 with a cover removed to show cell stacks within an interior area of the battery pack.

FIG. 3 illustrates a perspective view of a portion of a cell stack from the battery pack of FIG. 2.

FIG. 4 illustrates a cell stack from the battery pack of FIG. 2 prior to installation within an enclosure structure of the battery pack and when being compressed at a compression table.

FIG. 5 illustrates a gripping system positioned over a cell stack of FIG. 3.

FIG. 5A illustrates a close-up view of an area of FIG. 5.

FIG. 6 illustrates the gripping system gripping the cell stack of FIG. 5 after removing the cell stack from the compression table.

FIG. 7 illustrates the cell stack gripped by the gripping system of FIG. 5 as the gripping system is positioning the cell stack over an enclosure tray of the battery pack of FIG. 2.

FIG. 8 illustrates the cell stack gripped by the gripping system of FIG. 5 after partially inserting the cell stack in the enclosure tray.

FIG. 9 illustrates the cell stack after a pusher of the gripping system has inserted the cell stack fully into the enclosure tray.

### DETAILED DESCRIPTION

This disclosure details exemplary gripping systems used to install a cell stack within an enclosure tray. The gripping systems can interface with short sides of battery cells of the cell stack to apply a clamp load along a length of the cell stack.

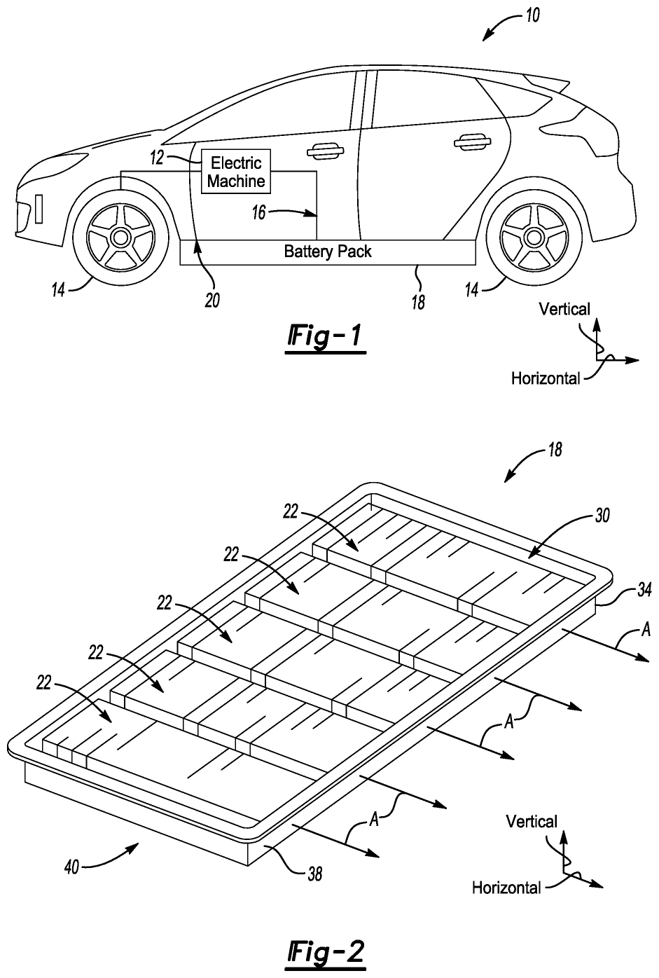

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEVs), fuel cell vehicles, etc. Therefore, although not specifically shown in the exemplary embodiment, the powertrain of the electrified vehicle 10 could be equipped with an internal combustion engine that can be employed either alone or in combination with other power sources to propel the electrified vehicle 10.

In the illustrated embodiment, the electrified vehicle 10 is depicted as a car. However, the electrified vehicle 10 could alternatively be a sport utility vehicle (SUV), a van, a pickup truck, or any other vehicle configuration.

Although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component, assembly, or system.

In the illustrated embodiment, the electrified vehicle 10 is a full electric vehicle propelled solely through electric power, such as by one or more electric machines 12, without assistance from an internal combustion engine. The electric machine 12 may operate as an electric motor, an electric generator, or both. The electric machine 12 receives electrical power and can convert the electrical power to torque for driving one or more wheels 14 of the electrified vehicle 10.

A voltage bus 16 electrically couples the electric machine 12 to a traction battery pack 18. The traction battery pack 18 is a high voltage traction battery pack assembly that includes a plurality of battery cells capable of outputting electrical power to power the electric machine 12 and/or other electrical loads of the electrified vehicle 10.

The example traction battery pack 18 is secured to an underbody 20 of the electrified vehicle 10. However, the traction battery pack 18 could be located elsewhere on the electrified vehicle 10 in other examples.

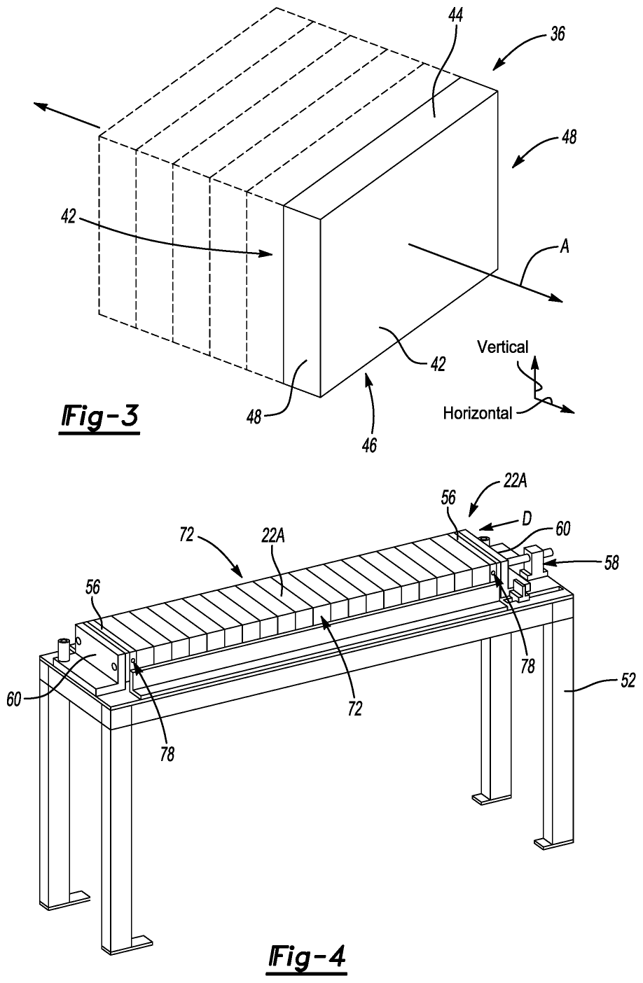

With reference to FIGS. 2 and 3, the traction battery pack 18 includes a plurality of cell stacks 22 housed within an interior area 30 of an enclosure. Here the cell stacks 22 fit within an enclosure tray 34, which can be secured to an enclosure cover, the underbody 20, or both to enclose the cell stacks 22 and other battery internal components within the interior area 30.

Each cell stack 22 includes a plurality of battery cells 36 stacked side-by-side relative to one another along a respective cell stack axis A. Walls 38 of the enclosure tray 34 maintain a compressive load on the cell stacks 22 along each cell stack axis A. The cell stacks 22 are disposed on a floor 40 of the enclosure tray 34. A thermal exchange plate (not shown) may be sandwiched between the floor 40 and the cell stacks 22.

The battery cells 36 store and supply electrical power for powering various components of the electrified vehicle 10. In the exemplary embodiment, the battery cells 36 are prismatic lithium-ion, battery cells. However, battery cells having other geometries and/or chemistries (nickel-metal hydride, lead-acid, etc.) could alternatively be utilized within the scope of this disclosure.

Each of the battery cells 36 has a pair of opposing axially facing sides 42, an upper side 44, a lower side 46, and a pair of opposing laterally facing sides 48. Upper and lower, as well as vertical and horizontal, are, for purposes of this disclosure, with reference to ground and a general orientation of the battery pack 18 when installed within the vehicle 10.

Within the cell stacks 22, the axially facing sides 42 face axially along the respective cell stack axis A and interface with other battery cells 36 within the cell stack 22. One of the axially facing sides 42 of the battery cells 36 at the axial ends of the cell stacks 22 interface with one of the walls 38. The upper sides 44 face upwards. The lower sides 46 face downward toward the floor 40. The laterally facing sides 48 face horizontally outward away from the respective cell stack axis A. A longest length of the laterally facing sides 48 is shorter than a longest length of other sides of the battery cell 36. The laterally facing sides 48 can thus be considered “short sides” of the battery cell 36.

In addition to the battery cells 36, the cell stacks 22 can additionally include dividers, thermal interface materials, adhesives, and other materials between the individual battery cells 36. Although a specific number of the cell stacks 22 are illustrated in the various figures of this disclosure, the traction battery pack 18 could include any number of cell stacks 22.

The battery cells 36 of the cell stacks 22 can be positioned between a pair of cross-member assemblies (not shown) such that the battery cells 36 are alongside the cross-member assemblies. The cross-member assemblies can be configured to enhance the structural integrity of the traction battery pack 18. The cross-member assemblies can be configured to transfer a load applied to a side of the electrified vehicle 10.

In an embodiment, the cell stacks 22 and the cross-member assemblies extend longitudinally in a cross-vehicle direction of the electrified vehicle 10. However, other configurations are contemplated within the scope of this disclosure.

Among other functions, the cross-member assemblies may be configured to hold the battery cells 36 and at least partially delineate the cell stacks 22 from one another within the interior area 30. The cross-member assemblies can carry busbars in some examples.

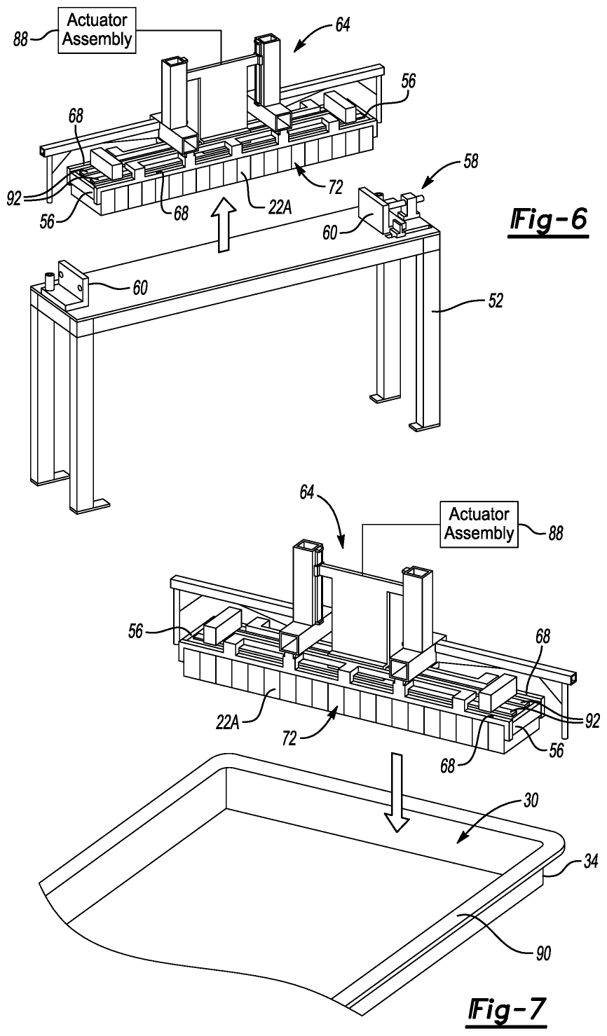

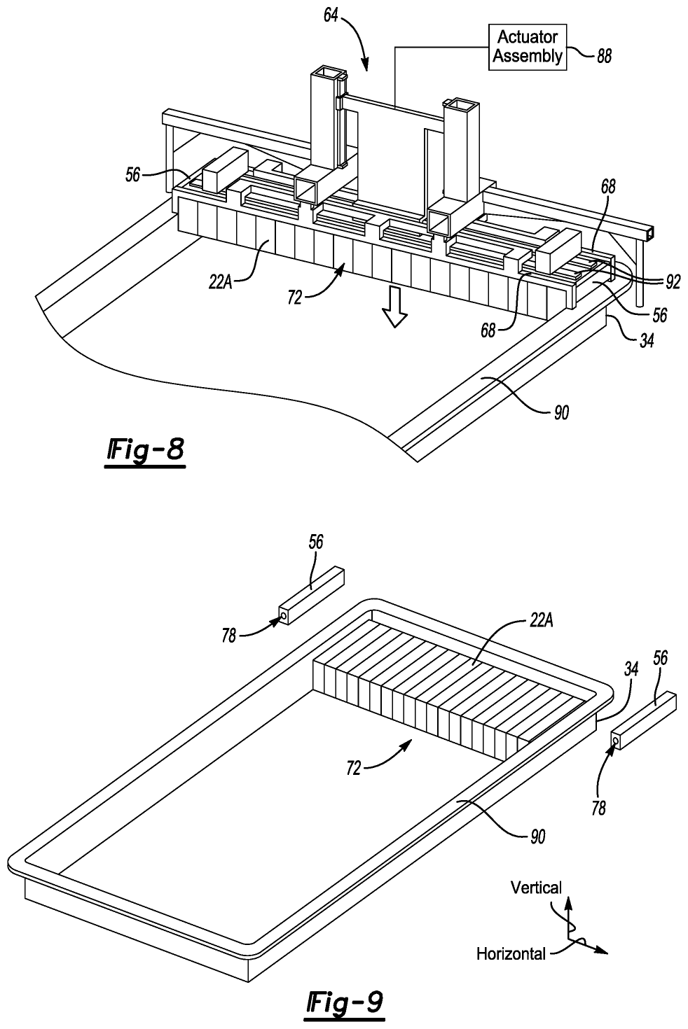

The battery cells 36 of the cell stacks 22 are compressed along their respective cell stack axes prior to and during installation within the enclosure tray 34. With reference now to FIGS. 4-9 and continuing reference to FIGS. 2 and 3, a method of installing the cell stacks 22 is shown in connection with one of the cell stacks 22A. The method maintains compression of the cell stacks 22 as the cell stacks 22 are installed within the enclosure tray 34.

The method of installing the cell stack 22A involves arranging the battery cells 36 of the cell stack 22A along the cell stack axis A upon a compression table 52 as shown in FIG. 4. The battery cells 36 of the cell stack 22A are positioned between clamp plates 56, which are disposed at opposing axial ends of the cell stack 22A.

The compression table 52 includes a vice assembly 58 having jaws 60. The clamp plates 56 and the cell stack 22A are sandwiched between jaws 60 of the vice assembly 58. One of the jaws 60 is then moved in a direction D to move the jaws 60 closer to each other and apply a desired clamp load to the battery cells 36 of the cell stack 22A along the cell stack axis A.

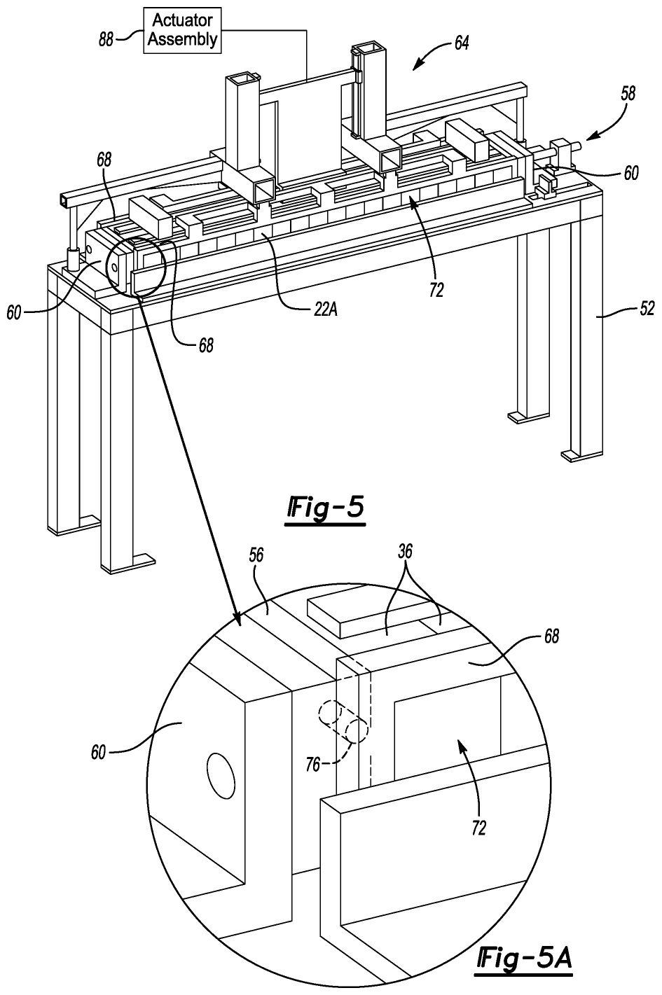

Next, as shown in FIGS. 5 and 5A, a gripping system 64 is positioned over the cell stack 22A. The gripping system 64 includes a pair of gripper bars 68 positioned along respective horizontally facing sides 72 of the cell stack 22A. The opposing laterally facing sides 48 of the battery cells 36 in the cell stack 22A provide the majority of the horizontally facing sides 72 of the cell stack 22A.

When the gripping system 64 is positioned over the cell stack 22A as shown in FIG. 4, the gripper bars 68 are then moved closer to each other into an engaged position with the cell stack 22. In the engaged position, the gripper bars 68 directly interface with and contact the horizontally facing sides 72 to grip the cell stack 22A. The surfaces of the gripper bars 68 that contact the horizontally facing sides 72 include liners, such as strips of rubber, to inhibit scratching of the battery cells 36 and other components of the cell stack 22A as well as to enhance the gripping.

In this example, the gripper bars 68 also each transition from an uncoupled position to a coupled position with each of the clamp plates 56 when the gripper bars 68 are moved to the engaged position. Coupling the clamp plates 56 to the gripper bars 68 fixes the position of the clamp plates 56 relative to each other along the cell stack axis A.

Coupling the gripper bars 68 to the clamp plates 56, in this example, involves inserting pins 76 of the gripper bars 68 into a respective aperture 78 of the clamp plates 56. The gripper bars 68 each include two pins 76 in this example. The pins 76 are disposed at opposite end portions of the gripper bars 68. For a given one of the gripper bars 68, one of the pins 76 is received within the aperture 78 of one of the clamp plates 56, and the other of the pins 76 is received within the aperture 78 of the other clamp plate 56.

Of course, in other examples, pins could be provided in the clamp plates 56 with corresponding apertures in the gripper bars 68. Other examples could include other ways of coupling the gripper bars 68 to the clamp plates 56 when the gripper bars 68 are moved to the engaged position.

An actuator assembly 88 is used to move the gripper bars 68 of the gripping system 64 closer to each other into the engaged position and then further from each other into a disengaged position where the gripper bars 68 are spaced from the horizontally facing sides 72 of the cell stack 22A. The actuator assembly 88 can additionally move the gripping system 64 and actuate other parts of the gripping system 64.

The actuator assembly 88 is shown schematically in FIG. 5. The actuator assembly 88 can include one or more robots and pneumatic actuators, for example. Alternatively, the actuator assembly could be hydraulically actuated. A person having skill in this art and the benefit of this disclosure would understand how to configure an actuator assembly capable of moving the gripper bars 68 and making the other movements of the gripping system 64 described in connection with the exemplary embodiment.

After gripping the short sides of the battery cells 36 of the cell stack 22A with gripper bars 68, the clamp load applied to the cell stack 22A by the jaws 60 of the vice assembly 58 is reduced to release the cell stack 22A from the vice assembly 58. The clamp load on the cell stack 22A along the cell stack axis A is maintained, however, due the clamp plates 56 being engaged with the clamp plates 56. The coupling of the gripper bars 68 to the clamp plates 56 blocks the clamp plates 56 from moving axially, which maintains the clamp load on the cell stack 22A.

The actuator assembly 88 then moves the gripping system 64 upward away from the compression table 52 to withdrawn the cell stack 22A from the compression table 52. Again, the position of the clamp plates 56 relative to each other along the cell stack axis A remains fixed due to the coupling of the gripper bars 68 to the clamp plates 56. A robot, for example, could be used to lift and reposition the gripping system 64.

The gripping system 64 with the cell stack 22A is moved to a position over the enclosure structure, here the enclosure tray 34 as shown in FIG. 7, and then moved downward to press the cell stack 22A into the enclosure tray 34. The cell stack 22A is inserted into the enclosure tray 34 until the clamp plates 56 contact or come close to contacting an edge 90 of the enclosure tray 34.

The clamp plates 56, in this example, are not inserted into the interior area 30 of the enclosure tray 34. This is because the clamp plates 56 interface with respective vertically upper portions of the opposing axially facing sides 42 of the battery cells 36 at the ends of the cell stack 22A. Thus, a lower portion of the cell stack 22A can be partially inserted into the enclosure tray 34 without interference from the clamp plates 56. The lower portion of the opposing axially facing sides 42 of the battery cells 36 can slide against the walls 38 as the cell stack 22A is pressed into the enclosure tray 34.

After partially inserted the cell stack 22A, the gripper bars 68 are moved away from each other to release the cell stack 22A and decoupled the gripper bars 68 from the clamp plates 56. The walls 38 of the enclosure tray 34 block expansion of the cell stack 22A along the cell stack axis A and maintain a clamp load of the battery cells 36 within the cell stack 22A.

The gripping system 64 includes at least one pusher 92 that is moved to press against the vertically upper sides 44 of the battery cells 36 in the cell stack 22A, which presses the cell stack 22A the remaining vertical distance into the enclosure tray 34. The cell stack 22A is moved vertically into the enclosure tray 34 until reaching an installed position shown in FIG. 9. The gripping system 64 can then be moved away from the cell stack 22A, leaving the cell stack 22A within the enclosure tray 34 in the installed position. When in the installed position, the walls 38 of the enclosure tray 34 maintain a clamp load on the battery cells 36 of the cell stack 22A. Additional cell stacks 22A can then be added to the enclosure tray 34 in a similar manner.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A cell stack gripping system, comprising:
a first gripper bar;
a second gripper bar;
a first clamp plate;
a second clamp plate; and
an actuator assembly that moves the first and second gripper bars from a disengaged position with a cell stack to an engaged position with the cell stack,
in the disengaged position, the first and second gripper bars are spaced further from each other than when the first and second gripper bars are in the engaged position,
in the engaged position, the first and second gripper bars grip opposing sides of a cell stack having a plurality of battery cells disposed along a cell stack axis, the opposing sides facing outward away from the cell stack axis,
in the engaged position, the first and second gripper bars couple to the first and second clamp plates to hold an axial position of the battery cells along the cell stack axis.

2. The cell stack gripping system of claim 1, wherein the opposing sides are horizontally facing sides.

3. The cell stack gripping system of claim 1, wherein the first and second gripper bars directly contact short sides of the battery cells when the first and second gripper bars are in the engaged position.

4. The cell stack gripping system of claim 1, further comprising coupling the first and second gripper bars to the first and second clamp plate using a plurality of pins received within respective apertures.

5. The cell stack gripping system of claim 1, wherein the clamp plates directly interface with opposing axially facing surfaces of the cell stack when the first and second gripper bars are in the engaged position.

6. The cell stack gripping system of claim 5, wherein the clamp plates directly interface with vertically upper portions of the opposing axially facing surfaces.

7. The cell stack gripping system of claim 1, further comprising at least one pusher that presses the cell stack into an enclosure structure when the first and second gripper are in the disengaged position.

8. The cell stack gripping system of claim 7, wherein the enclosure structure is an enclosure tray that compresses the cell stack.

9. A cell stack gripping method, comprising:
positioning first and second gripper bars along opposing sides of a cell stack, the cell stack including a plurality of battery cells disposed along a cell stack axis, the plurality of battery cells sandwiched axially between first and second clamp plates during the positioning; and
moving the first and second gripper bars toward each other into an engaged position to couple to clamp the cell stack between the first and second gripper bars and to engage first and second clamp plates.

10. The gripping method of claim 9, further comprising compressing the cell stack axially prior to the positioning.

11. The gripping method of claim 10, further comprising maintaining the compressing during the moving.

12. The gripping method of claim 10, further comprising compressing the cell stack axially at a compression table prior to the positioning.

13. The gripping method of claim 12, further comprising withdrawing the cell stack from the compression table after the moving while maintaining compression on the cell stack.

14. The gripping method of claim 13, further comprising inserting the cell stack into an enclosure structure.

15. The gripping method of claim 14, further comprising moving the first and second gripper bars away from each other into a disengaged position, and then pressing the cell stack into the enclosure structure.

16. The gripping method of claim 15, further comprising maintaining compression on the cell stack with the enclosure structure after the moving the gripper bars to the disengaged position.

17. The gripping method of claim 9, wherein the first and second gripper bars directly contact horizontally facing sides of the plurality of battery cells when the gripper bars are in the engaged position.

18. The gripping method of claim 9, wherein the first and second gripper bars directly contact short sides of the plurality of battery cells when the gripper bars are in the engaged position.
